(19) United States
(12) Patent Application Publication
(10) Pub. No.: US 2026/0001230 A1
(43) Pub. Date: Jan. 1, 2026

(54) METHOD FOR DETERMINING GRIPPING SEQUENCE CONTROLLER, AND COMPUTER READABLE STORAGE MEDIUM

(71) Applicant: ABB SCHWEIZ AG, Baden (CH)

(72) Inventors: Changnian Qian, Shanghai (CN); Lei Mao, Shanghai (CN); Dingli Bao, Shanghai (CN)

(21) Appl. No.: 19/319,395

(22) Filed: Sep. 4, 2025

Related U.S. Application Data
(63) Continuation of application No. PCT/CN2023/081120, filed on Mar. 13, 2023.

(51) Int. Cl. B25J 9/16; B65G 59/04

(52) U.S. Cl. CPC B25J 9/1687; B25J 9/1697; B65G 59/04

(57) ABSTRACT

Embodiments of present disclosure relate to a method of determining a gripping sequence of cases in a case stack for a gripper. The method includes obtaining at least one finger geometry of the plurality of fingers. The method includes determining a layout for a case layer of the case stack. The method includes determining a grip area for each case in the case layer and based on the layout and the at least one finger geometry. The grip area is dimensioned to allow the plurality of fingers to grip the sidewalls in the grip area; detecting overlaps of the grip area of each case with neighbor cases of each case. The method includes determining the gripping sequence for the case layer based on the detected overlaps. In this way, the gripping sequence can be automatically determined to allow the gripper to depalletize the case stack successively.

### FIELD

Embodiments of the present disclosure generally relate to the field of robotics, and more particularly, to a method for determining a gripping sequence, a controller, and a computer readable storage medium.

### BACKGROUND

Depalletizing is one of the most typical industrial robot applications. One of the applications is depalletizing transfer cases in a case stack. The transfer cases are usually open in the top. Therefore, the grippers cannot grip the transfer cases on the top. Normally, there is a plurality of cases in a case layer and sometimes the cases in on case layer are irregularly placed. That is, some transfer case is neither perpendicular nor parallel to other cases. Under these circumstances, the grippers have to find the target case that can be picked up by the current type of gripper and grip the transfer cases in a specific pose corresponding to the irregular pose of the transfer case. Therefore, a mechanism to determine the poses and sequence of the transfer cases to be picked up is highly desired.

### SUMMARY

In view of the foregoing problems, example embodiments of the present disclosure propose solutions for determining a gripping sequence to achieve successful depalletizing of a case stack.

In a first aspect of the present disclosure, example embodiments of the present disclosure provide a method of determining a gripping sequence of cases in a case stack for a gripper. The gripper comprises a plurality of fingers for gripping sidewalls of a case. The method comprising: obtaining at least one finger geometry of the plurality of fingers and a layout for a case layer of the case stack; determining, for each case in the case layer and based on the layout and the at least one finger geometry, a grip area dimensioned to allow the plurality of fingers to grip the sidewalls in the grip area; detecting overlaps of the grip area of each case with neighbor cases of each case; and determining the gripping sequence for the case layer based on the detected overlaps.

With these embodiments, a grip area wide enough to allow the gripper to access the sidewall of the case is determined and the overlaps of the grip area of a case with its neighbor cases may indicate how to pick up the cases. Therefore, a gripping sequence can be derived based on the detected overlaps. In this way, the gripping sequence can be automatically determined to allow the gripper to depalletize the case stack successively.

In some example embodiments, wherein determining the gripping sequence comprises: determining whether each case in the case layer is pickable based on the detected overlaps; selecting one pickable case as a target case; and adding the target case into the gripping sequence. With these embodiments, the pickable cases can be successively picked up by the gripper without moving other cases.

In some example embodiments, determining the gripping sequence comprises: obtaining a finger configuration indicating at least one set of target sidewalls of a case to be gripped by the fingers; determining at least one subarea in the grip area corresponding to the at least one set of target sidewalls; determining the overlaps of the at least one subarea with neighbor cases of the case; and determining whether the case is pickable based on the overlaps of the at least one subarea. With these embodiments, by configuring the subareas corresponding to the at least one set of target sidewalls of case, the accuracy of determining whether a case is pickable is improved.

In some example embodiments, determining whether each case is pickable comprises: in response to determining that one of the at least one subarea overlaps with at least one neighbor case, determining the case as pickable. Alternatively, determining whether each case is pickable comprises: in response to determining that each of the at least one subarea of a case overlaps with at least one neighbor case, determining the case as unpickable. With these embodiments, as long as one subarea of the case is clear of neighbor cases, the case can be picked up by the gripper. Only if none of the subareas is clear of neighbor cases, the case cannot be picked up by the gripper.

In some example embodiments, selecting the one pickable case comprises: in response to determining only one case in the case layer as pickable, selecting the only one case into the gripping sequence.

In some example embodiments, selecting the one pickable case comprises: in response to determining a plurality of cases as pickable, obtaining a reference point in the case layer; determining respective distances between the plurality of cases and the reference point; and adding a case of the plurality of cases having a minimum distance to the reference point into the gripping sequence. In these embodiments, the reference point may be the original point of the layout. With these embodiments, when more than one pickable cases are found, the nearest one to the reference point may be selected.

In some example embodiments, determining the gripping sequence further comprises: maintaining an overlap list for each sub area of each case based on the detected overlaps; updating overlap lists of neighbor cases of a case by removing overlaps with the case from the overlap lists after the case is added into the gripping sequence. With these embodiments, the detected overlaps are organized as respective overlap lists of all the cases in the case layer. When one case has been added into the gripping sequence, the overlap list may be updated by removing the added case from the overlap lists of its neighbor cases. In this way, it is unnecessary to detect the overlaps in the layout without the added cases thereby simplifying the whole procedure of determining the gripping sequence.

In some example embodiments, the finger configuration indicates a corner of a case connecting two adjacent target sidewalls. In these embodiments, the method further comprises: determining two adjacent target sidewalls connected at the corner as a first set of the two sets of target sidewalls; and determining the other two sidewalls as a second set of the two sets of target sidewalls. With these embodiments, the two sets of target sidewalls can be determined by only one corner indication. In this way, the procedure of determining of target sidewalls is simplified.

In some example embodiments, determining the two adjacent target sidewalls comprises; identifying four corners of a case; assigning the four corners with predefined indicators; determining a corner with an indicator corresponding to the finger configuration; determining two target sidewalls connected at the corner. With these embodiments, in order to associate the corners with the indicators, the four corners of the all the cases will be labeled in the same pattern. In this way, the two sets of target sidewalls can be accurately determined.

In some example embodiments, one of the two subareas includes: a first segment adjoining a first sidewall of a set of target sidewalls corresponding to the one subarea; a second segment adjoining a second sidewall of the pair of adjacent sidewalls; and a third segment adjoining the first segment and the second segment.

In some example embodiments, the case stack includes a plurality of case layers. In these embodiments, determining the gripping sequence comprises: determining respective gripping sequence for each case layer in a sequence from a top case layer to a bottom case layer of the case stack.

In some example embodiments, the method further comprises: in response to selecting a case to be added into the gripping sequence, determining a position and a pose of the case in the layout; and determining a grip position and a grip pose of the gripper for gripping the case. With these embodiments, along with the gripping sequence, the grip position and the grip pose for each case in the gripping sequence are determined for the actual depalletizing operation.

In some example embodiments, obtaining the layout for the case layer comprises: obtaining an image of a top view of the case layer captured by a camera; and generating a layout based on the image. In this case, the layout comprises profiles of cases in the case layer arranged according to poses of the cases in the image. With these embodiments, the layout can be accurately generated with the aid of machine vision.

In some example embodiments, a size of the profiles of cases is greater than a size of the case in the image by a predefined tolerance. With these embodiments, by setting a tolerance to the profiles in the layout, failures caused by inaccuracies of the image system can be avoided.

In some example embodiments, determining the grip area comprises: determining a predefined threshold distance based on the at least one finger geometry; and determining a width between an inner perimeter of the grip area and an outer perimeter of the grip area to be equal to the predefined threshold distance. In some example embodiments, the predefined threshold distance is greater or equal to a length of a finger along a direction perpendicular to a sidewall of the case when the finger is gripping the sidewall. With these embodiments, the predefined threshold distance is determined such that the gripper can be received in the grip area.

In a second aspect, example embodiments of the present disclosure provide a controller. The controller comprises: at least one processor; and at least one memory storing instructions that, when executed by the at least one processor, cause the computing device to perform the method for adjusting a robot path.

In a third aspect, example embodiments of the present disclosure provide a computer readable medium having instructions stored thereon, the instructions, when executed on at least one processor, cause the at least one processor to perform the method for adjusting a robot path.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1A schematically illustrates a block diagram of an example environment in which example embodiments of the present disclosure can be implemented;

FIG. 1B schematically illustrates a perspective bottom view of a gripper and a case in accordance with embodiments of the present disclosure;

FIGS. 1C-1D schematically illustrate top views of a gripper griping a case in accordance with embodiments of the present disclosure;

FIG. 2 schematically illustrates a flowchart of a method for determining a gripping sequence in accordance with embodiments of the present disclosure;

FIG. 3A schematically illustrates a schematic diagram of a case stack in accordance with embodiments of the present disclosure;

FIG. 3B schematically illustrates a schematic diagram of a grip area of a case in accordance with embodiments of the present disclosure;

FIG. 3C schematically illustrates a schematic diagram of an overlap table in accordance with embodiments of the present disclosure;

FIG. 4A schematically illustrates a flowchart of a method for determining a gripping sequence based on the overlaps in accordance with embodiments of the present disclosure;

FIG. 4B schematically illustrates a flowchart of a method for determining whether a case is pickable in accordance with embodiments of the present disclosure;

FIGS. 5A-5D schematically illustrate diagrams of a layout and respective overlap table in accordance with embodiments of the present disclosure;

FIG. 5E schematically illustrate an update procedure of an overlap table in accordance with embodiments of the present disclosure; and

FIG. 6 schematically illustrates a schematic diagram of a controller for implementing a method in accordance with embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, conventionally, the tools used for depalletizing are mostly vacuum grippers. The vacuum grippers may grip objects in a stack on a top surface by suction. In this case, the vacuum grippers may always be able to access the objects from above. However, transfer cases are usually open in the top and therefore the top surface cannot be accessed. Therefore, in order to pick up the transfer cases, the grippers need to access the sidewalls of the transfer cases and grip the transfer cases on the sidewalls. In this case, the transfer cases may be stacked irregularly and the space between some transfer cases is not wide enough to allow the fingers of a grip to deploy. In this regard, the transfer cases cannot be picked up in a predefined fixed sequence.

In view of the above, a new method is provided for determining a gripping sequence according to embodiments of the present disclosure. In general, the grippers have a plurality of fingers for gripping cases in a case layer on the sidewalls. A layout of the case layer is generated to determine a grip area surrounding the sidewalls of each case. The grip area has a dimension such that the fingers are allowed to access the sidewalls of the case in the grip area. For each case in the case layer, overlaps of the grip area with its neighbor cases are checked. The overlaps may indicate whether a case is pickable and a gripping sequence to depalletize the case stack can be determined based on the detected overlaps. In this way, the gripping sequence can be automatically determined to allow the gripper to depalletize the case stack successively.

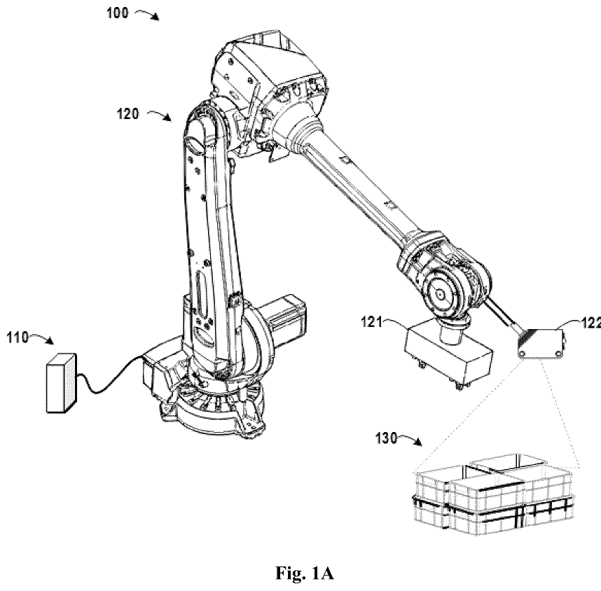

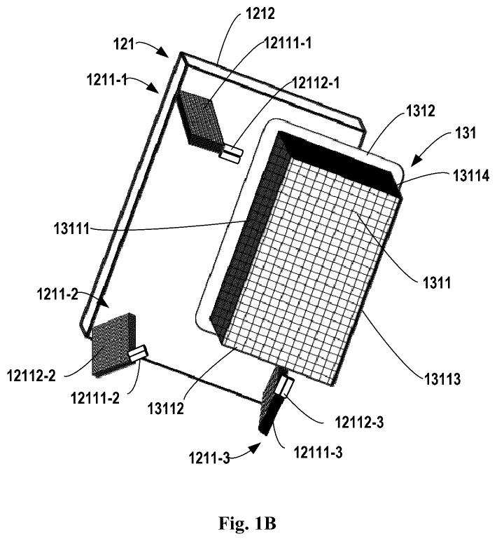

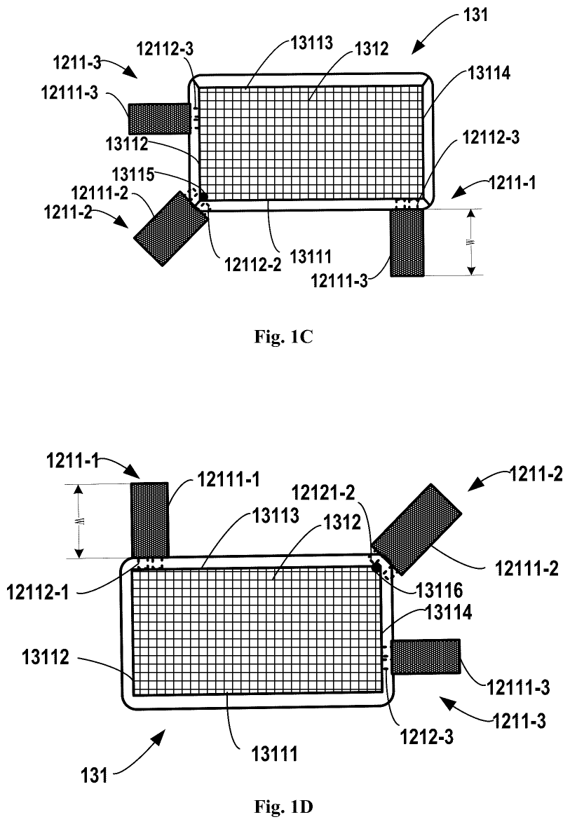

A framework in accordance with embodiments of the present disclosure will be described with reference to FIG. 1A. FIG. 1A schematically illustrates a block diagram of an example environment 100 in which example embodiments of the present disclosure can be implemented. As illustrated in FIG. 1A, the environment 100 includes a robot 120 and a controller 110 coupled to the robot 120. The controller 110 may control the movement of the robot 120 for different operations. The robot 120 includes an end effector which is implemented as a gripper 121. The gripper 121 may pick up cases 131 in a case stack 130 sequentially and place the cases 131 to a different storage position to complete depalletizing of the case stack 30. The robot 120 further includes a camera 122 to capture images of the case stack 130 or other target object to provide vision data for machine vision related applications.

FIG. 1B schematically illustrates a perspective bottom view of the gripper 121 and a case 131 in accordance with embodiments of the present disclosure. As illustrated in FIG. 1i, the gripper 121 has three fingers 1211-1, 1211-2, 1211-3 (collectively referred to as fingers 1211) provided under a support 1212 for gripping respective sidewalls 13111, 13112, 13113, 13114 of the case 131. In the illustrated embodiment, the finger 1211-1 is provided at a longer edge of the support 1212 for gripping an end area of a longer sidewall 13111 of the case 131. The finger 1211-1 has a finger body 12111-1 and a fingertip 12112-1. The finger 1211-2 is provided at the corner of the support for gripping the corner area adjoining the sidewall 13111 and the sidewall 13112 of the case 131. The finger 1211-2 has a finger body 12111-2 and a fingertip 12112-2. The finger 1211-3 is provided at a shorter edge of the support 1212 for gripping an end area of a shorter sidewall 13112 of the case 131. The finger 1211-3 has a finger body 12111-3 (collectively referred to as finger bodies 12111 with the finger body 12111-1 and the finger body 12111-2) and a fingertip 12112-3 (collectively referred to as fingertips 12112 with the fingertip 12112-1 and the fingertip 12112-2).

When the gripper 121 starts to grip the cases in the case stack, the fingertips 12112 are retracted in the finger bodies 12111 and the gripper 121 moves above the case 131. Then, the gripper 121 adjusts its pose according to the pose of a case 131 such that the finger 1211-1 is perpendicular to corresponding sidewall 13111 of the case 131 and the finger 1211-3 is perpendicular to the corresponding sidewall 13112. When the gripper 121 is aligned with the case 131, the gripper 121 descends until the fingers 121 moves to the side of the sidewalls. When the gripper 121 stops, the fingertips 12112 extend from the finger bodies 12111 towards the respective sidewalls. The fingertips 12112 extend below the collar 1312 of the case 131. Then, the gripper 121 ascends such that the fingertips 12112 may lift the collar 1312 of the case 131. It should be appreciated that a segment of the collar 1312 adjoining a sidewall may be viewed as part of the sidewall. In some example embodiments, the cases may not have collars but recesses in the sidewall. In these embodiments, the fingertips 12112 may extend into the recesses to engage with the sidewalls of the case.

In the illustrated embodiment, the four sidewalls of the case may be divided into two sets. A first set may include the sidewall 13111 and sidewall 13112 and a second set may include the sidewall 13113 and sidewall 13114 to be gripped by the gripper (also referred to as target sidewall). FIG. 1C schematically illustrates top views of a gripper 121 griping a case 131 in accordance with embodiments of the present disclosure. As illustrated in FIG. 1C, the gripper 121 grips the case 131 on the first set of the sidewalls. The finger 1211-1 grips the sidewall 13111, the finger 1211-3 grips the sidewall 13112 and the finger 1211-2 grips the corner 13115 connecting the sidewall 13111 and the sidewall 13112. The length of the finger 1211 along a direction perpendicular to the sidewall 13111 is W.

In addition, FIG. 1D schematically illustrates top views of a gripper 121 griping a case 131 in accordance with embodiments of the present disclosure. As illustrated in FIG. 1D, compared with the pose of the gripper 121 as illustrated in FIG. 1C, the pose of the gripper 121 turns 180° and grips the case 131 on the second set of the sidewalls. In particular, the finger 1211-1 grips the sidewall 13113, the finger 1211-3 grips the sidewall 13114 and the finger 1211-2 grips the corner 13116 connecting the sidewall 13113 and the sidewall 13114.

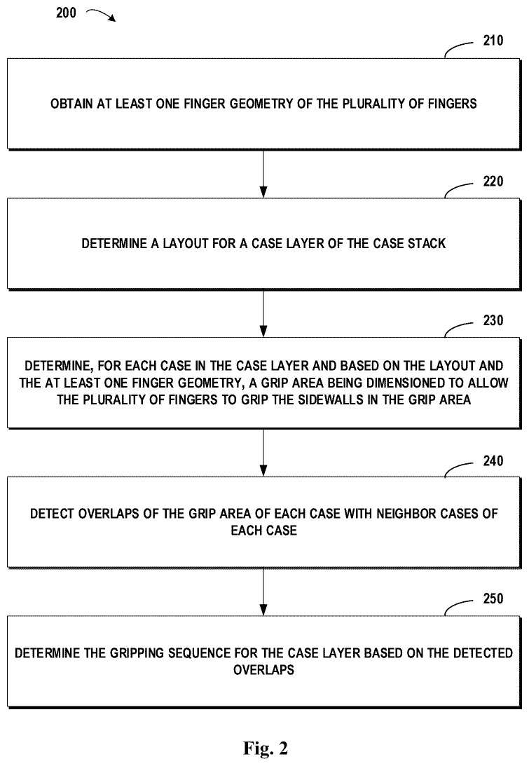

Hereinafter, reference will be made to FIGS. 2 to 5F for more details about the method in accordance with the present disclosure.

FIG. 2 schematically illustrates a flowchart of a method 200 for determining a gripping sequence in accordance with embodiments of the present disclosure. For the purpose of discussed, the method 200 will be described in association with FIGS. 1A-1D. The method 200 may be implemented by the controller 110 in FIG. 1A.

At 210, the controller 110 obtains at least one finger geometry of the plurality of fingers. The finger geometry may include a length, a width and a height of the finger body and a length of the fingertip. In some example embodiments, the at least one finger geometry of different fingers may be different. Alternatively, the fingers are of the same size and the at least one finger geometry is the same.

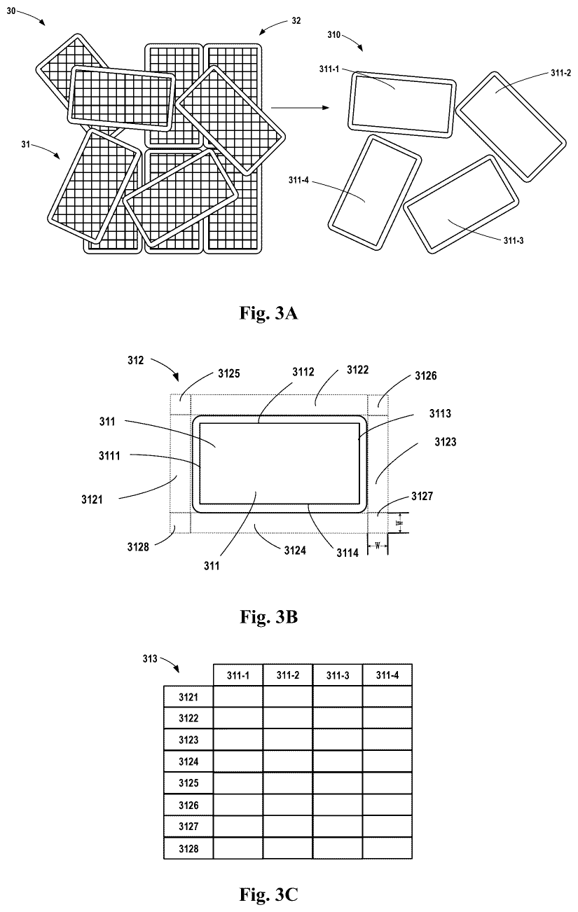

At 220, the controller 110 determines a layout for a case layer of the case stack. A layout for the case layer may be proportionally scaled from an image of the case layer for example captured by the camera 122 illustrated in FIG. 1A. The layout may be a digital representation of the profiles of the cases. The profiles of the cases are arranged according to the poses of the cases in the captured image. FIG. 3A schematically illustrates a schematic diagram of a case stack 30 in accordance with embodiments of the present disclosure. As illustrated in FIG. 3A, the case stack 30 includes two layers, a top case layer 31 and a bottom case layer 32. A layout 310 of the case layer 31 is generated for example based on an image captured by the camera 122. The layout 310 comprises four profiles of cases 311-1, 311-2, 311-3, 311-4 corresponding to the poses of the cases in the case layer 31. In some embodiments, the gripping sequence may be determined layer by layer in a sequence from the top case layer 31 to the bottom case layer 32. For example, when the gripper 121 has depallitized the top case layer 31 according to a determined gripping subsequence, a gripping sequence of a case layer right under the top case layer will be determined. It should be appreciated that a case stack may include other case layers between the top case layer and the bottom case layer and the case stack may also include only one case layer. One case layer may include other numbers of cases.

Back to FIG. 2, at 230, the controller 110 determines a grip area surrounding sidewalls of each case in the case layer based on the layout and the at least one finger geometry. The grip area is dimensioned to allow the plurality of fingers to grip the sidewalls in the grip area. The grip area may represent a space between the case and its neighbor cases. The grip area has a dimension that wide enough to allow the fingers 1211 of the gripper 121 to reach the sidewalls without colliding with the neighbor cases.

FIG. 3B schematically illustrates a schematic diagram of a grip area 312 surrounding a profile 311 of a case in accordance with embodiments of the present disclosure. The grip area 312 has a shape of rectangular frame. A width of an inner perimeter of the grip area 312 and an outer perimeter of the grip area 312 is equal to a length W of the finger 1211 along a direction perpendicular to the sidewalls. The grip area 312 includes 8 segments. A segment 3121 is aligned with a sidewall edge 3111. A segment 3122 is aligned with a sidewall 3112. A segment 3123 is aligned with a sidewall 3113. A segment 3124 is aligned with a sidewall 3114. A segment 3125 adjoins or connects the segment 3121 and the segment 3122. A segment 3126 adjoins or connects the segment 3122 and the segment 3123. A segment 3127 adjoins or connects the segment 3123 and the segment 3124. A segment 3128 adjoins or connects the segment 3124 and the segment 3121. The segment 3121 and the segment 3123 may have a width of W and a length equal to a length of a shorter sidewall of the case. The segment 3122 and the segment 3124 may have a width of W and a length equal to a length of a longer sidewall of the case. The segment 3125, the segment 3126, the segment 3127 and the segment 3128 have a square shape and a size of the square is W×W.

In some example embodiments, a size of a profile in the layout may be greater than a size of the case in the image by a predefined tolerance.

At 240, the controller 110 detects overlaps of the grip area of each case with neighbor cases of each case. In the present application, a neighbor case of a case indicates that there is no other case between the neighbor case and the case. The overlap may indicate whether there is enough space for the fingers between cases.

In some embodiments, the detected overlaps may be organized in respective overlap lists for all the cases in the case layer. The overlap lists may also be comprised in an overlap table. FIG. 3C schematically illustrates a schematic diagram of an overlap table 313 in accordance with embodiments of the present disclosure. A data term in the overlap table 313 indicates which a neighbor case overlaps with respective segments of the grip area 312. If no neighbor case overlaps with the segment, the data term may be filled with null. In some example embodiments, the overlap table is updated when the layout of the case layer changes.

At 250, the controller 110 determines the gripping sequence for the case layer based on the detected overlaps. Since the detected overlaps may indicate whether it is possible for the gripper to grip the sidewalls of a case, a gripping sequence can be determined such that each case in the gripping sequence can be successfully picked by the gripper.

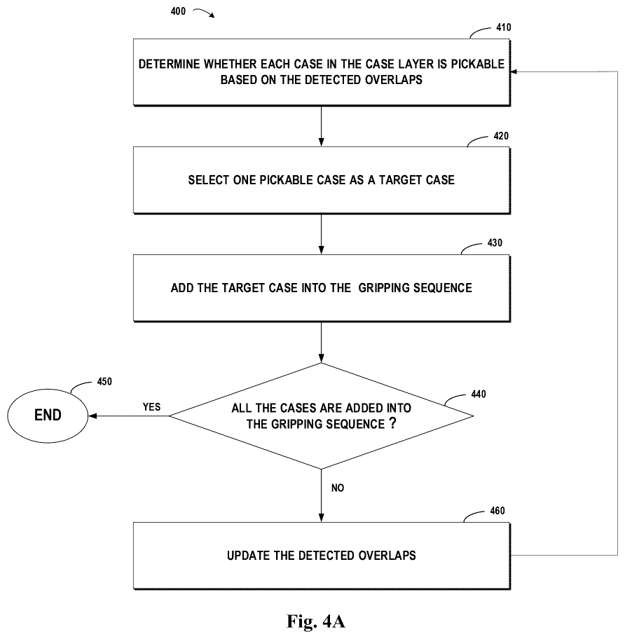

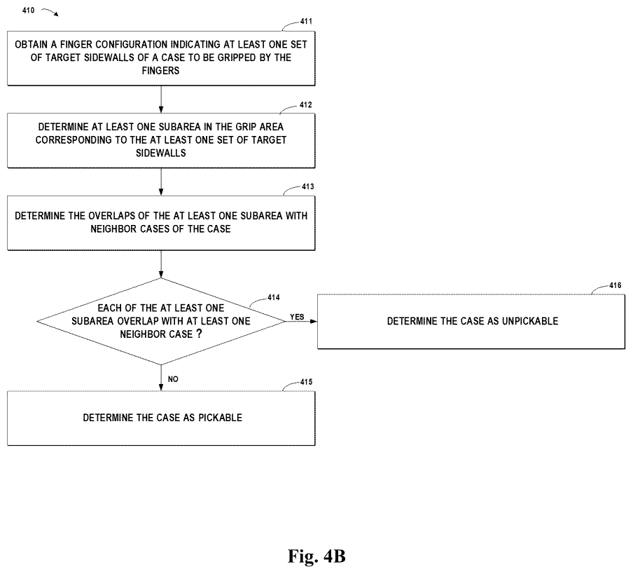

Hereinafter, the method for determining the gripping sequence based on the detected overlaps will be discussed in details with reference to FIGS. 4A-4B. FIG. 4A schematically illustrates a flowchart of a method 400 for determining a gripping sequence based on the overlaps in accordance with embodiments of the present disclosure. For the purpose of discussed, the method 200 will be described in association with FIGS. 1A-1D. The method 200 may be implemented by the controller 110 in FIG. 1A.

At 410, the controller 110 determines whether each case in the case layer is pickable based on the detected overlaps. If the grip area of one case overlaps with neighbor cases, the finger may not be able to reach sidewalls of the case which means the case is not pickable. If the grip area of one case overlaps with no neighbor cases, there is enough space for the finger which means the case is pickable. The method for determining whether a case is pickable will be described in details later with reference to FIG. 4B.

At 420, the controller 110 selects one pickable case as a target case. After it has been determined for each case in the case layer whether the case is pickable, one pickable case can be selected to be added into the gripping sequence. If only one case in the case layer is pickable, the only one case is selected as a target case.

In some example embodiments, more than one case in the case layer may be pickable. In these embodiments, one pickable case may be selected randomly. In some example embodiments, in order to select one target case from a plurality of pickable cases, a reference point in the layout may be obtained. The layout may be generated in one coordinate system. The points of the profiles in the layout are assigned with corresponding coordinate. The reference point may be any specific point in the coordinate system. For example, the reference point may be the original point of the coordinate system of the layout. In some example embodiments, the reference point may be a center point of all the cases.

At 430, the controller 110 adds the target case into the gripping sequence. Thereafter, at 440, the controller 110 determines whether all the cases are added into the gripping sequence. If the controller 110 determines that all the cases are added into the gripping sequence, the method proceeds to 450 and the method 400 ends at 450. Otherwise, the method proceeds to 460. At 460 the controller 110 updated the detected overlaps and then the method returns to 410 to select the next target case in based on the updated overlaps. In these embodiments, the cases in the gripping sequence can be determined sequentially based on the original detected overlaps and the detected overlaps updated each time.

In some example embodiments, after a target case is added into the gripping sequence, the controller may determine a position and a pose of the target case in the layout. Then, the controller determines a grip position and a grip pose of the gripper for gripping the target case.

In the embodiments that the detected overlaps are organized as an overlap table, after one target case is added into the gripping sequence, the overlap lists of neighbor cases of the one case is updated by removing overlaps with the one case from the overlap lists.

FIG. 4B schematically illustrates a flowchart of a method 410 for determining whether a case is pickable in accordance with embodiments of the present disclosure. For the purpose of discussed, the method 200 will be described in association with FIGS. 1A-1D. The method 200 may be implemented by the controller 110 in FIG. 1A. The method 410 is corresponding to the step 410 of method 400.

At 411, the controller 110 obtains a finger configuration indicating at least one set of target walls. In the embodiment as illustrated in FIGS. 1A-1D, one case includes four sidewalls. According to the finger configuration of the gripper 121, when the gripper 121 grips a case, two adjacent sidewalls of the case 131 is gripped by the fingers of the gripper. For example, the two adjacent sidewalls may be the sidewalls 13111 and the sidewall 13112 as illustrated in FIG. 1C, or the sidewalls 13113 and the sidewall 13114 as illustrated in FIG. 1D. In this circumstance, the sidewall to be gripped by the gripper may also be referred to as target sidewall. It should be appreciated that a number of sets of target sidewalls may vary according to the finger configuration. For example, when the gripper is configured to grip three sidewalls of a case, the case may have only one set of target sidewalls. The method 410 can be applied to the cases having any number of sets of target sidewalls.

At 412, the controller 110 determines at least one subarea in the grip area corresponding to the at least one set of target sidewalls. One subarea may include segments adjoining the target sidewalls. For example, in the embodiment as illustrated in FIG. 1C, one subarea may include a segment aligned with the sidewall 13111, a segment aligned with the sidewall 13112 and a segment adjoining the sidewall 13111 and the sidewall 13112. In addition, the other subarea may include a segment aligned with the sidewall 13113, a segment aligned with the sidewall 13114 and a segment adjoining the sidewall 13113 and the sidewall 13114.

At 413, the controller 110 determines the overlaps of the at least one subarea with neighbor cases of the case. In particular, the controller 110 may determine whether the segments of the subarea overlap with the neighbor cases.

At 414, the controller 110 determines whether each of the at least one subarea overlaps with at least one neighbor case. If the controller 110 determines that each of the at least one subarea overlaps with at least one neighbor case which means there is no enough space in each of the at least one subarea for the gripper, the method 410 proceeds to 416. At 416, the controller 110 determines that the case is unpickable. If the controller 110 determines that one of the at least one subarea does not overlap with any neighbor case, which means there is enough space in one of the two subareas for the fingers of the gripper, the method 410 proceeds to 415. At 415, the controller 110 determines that the case is pickable.

In these embodiments, subareas corresponding to the target sidewalls in the grip area are specified thereby avoiding failures of finding pickable cases which may be unable to be found based on overlaps of the entire grip area with neighbor cases.

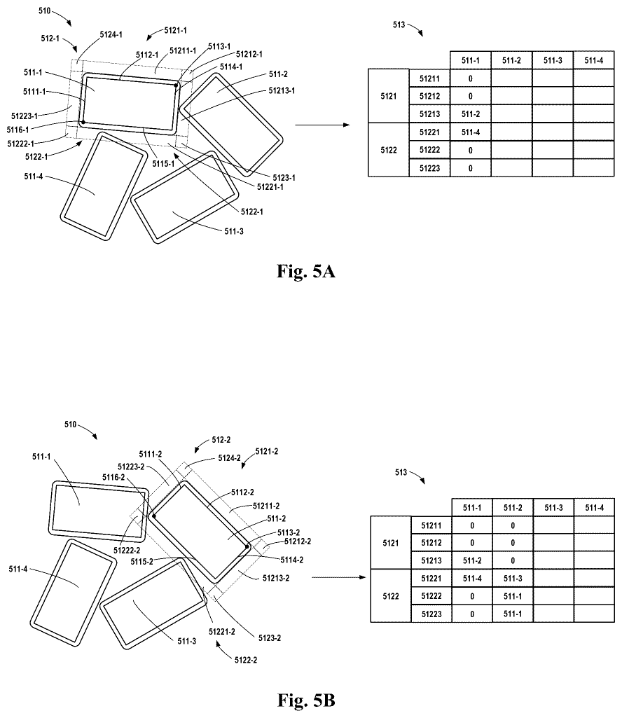

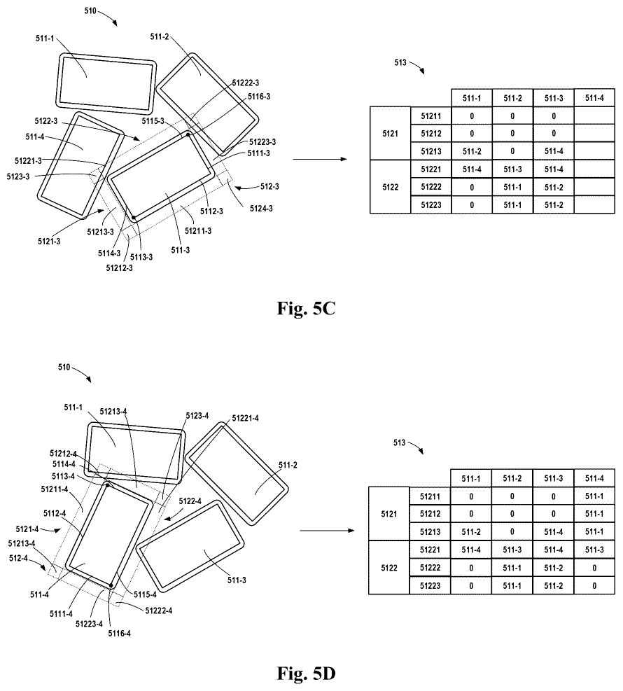

FIGS. 5A-5F schematically illustrate diagrams of layouts and respective overlap table for different cases in accordance with embodiments of the present disclosure. FIG. 5A schematically illustrates a diagram of a layout 510 of a case layer and an overlap table 513 in accordance with embodiments of the present disclosure. It should be appreciated that one grip area is determined for each case in the layout and for sake of clarity, only one grip area is illustrated in each of the FIGS. 5A-5D.

As illustrated in FIG. 5A, the layout 510 of a case layer includes a case 511-1, a case 511-2, a case 511-3 and a case 511-4. The case 511-1 includes four sidewalls 5111-1, 5112-1, 5114-1, 5115-1. According to a finger configuration, the gripper is configured to grip a sidewall 5112-1 and a sidewall 5114-1 connected at a corner 5113-1. That is, the sidewall 5112-1 and the sidewall 5114-1 form a first set of the target sidewalls. Further, a sidewall 5115-1 and a sidewall 5111-1 connected at a corner 5116-1 form a second set of the target sidewalls.

In some example embodiments, the four corners of each case may be identified based on the pose of the cases. The four corners are assigned with predefined indicators. For example, the four corners are assigned with indicators “1”, “2”, “3”, “4”. The finger configuration may include an indicator to indicate a corresponding corner connecting two target sidewalls. Therefore, the target sidewalls can be determined based on the indicator contained in the finger configuration.

The layout 510 further includes a grip area 512-1 surrounding the case 511-1. The grip area 512-1 includes a subarea 5121-1 corresponding to the first set of the target sidewalls and a subarea 5122-1 corresponding to the second set of the target sidewalls as well as a segment 5123-1 and a segment 5124-1. The subarea 5121-1 includes a segment 51211-1 aligned with the sidewall 5112-1, a segment 51213-1 aligned with the sidewall 5114-1 and a segment 51212-1 adjoining the segment 51211-1 and the segment 51213-1. The subarea 5122-1 includes a segment 51221-1 aligned with the sidewall 5115-1, a segment 51223-1 aligned with the sidewall 5111-1 and a segment 51222-1 adjoining the segment 51221-1 and the segment 51223-1.

As illustrated in FIG. 5A, the data item in the overlap table 513 represents a neighbor case overlapping with the corresponding segments of a subarea of a case. The data items are determined based on the detected overlaps of the grip area 512-1 with neighbor cases. For the case 511-1, the segment 51211-1 and the segment 51212-1 overlap with no neighbor case. The segment 51213-1 overlaps with the case 511-2. Therefore, the subarea 5121-1 overlaps with one neighbor case. Further, the segment 51222-1 and the segment 51223-1 overlap with no neighbor case. The segment 51221-1 overlaps with the case 511-4. Therefore, the subarea 5122-1 overlaps with one neighbor case. Based on that each subarea overlaps with one neighbor case, it is determined that the case 511-1 is unpickable.

FIG. 5B schematically illustrates a diagram of a layout 510 of a case layer and an overlap table 513 in accordance with embodiments of the present disclosure. As illustrated in FIG. 5B, the case 511-2 includes four sidewalls 5111-2, 5112-2, 5114-2, 5115-2. According to the finger configuration, the gripper is configured to grip a sidewall 5112-2 and a sidewall 5114-2 connected at a corner 5113-2. That is, the sidewall 5112-2 and the sidewall 5114-2 form a first set of the target sidewalls. Further, a sidewall 5115-2 and a sidewall 5111-2 connected at a corner 5116-2 form a second set of the target sidewalls.

The layout 510 further includes a grip area 512-2 surrounding the case 511-2. The grip area 512-2 includes a subarea 5121-2 corresponding to the first set of the target sidewalls and a subarea 5122-2 corresponding to the second set of the target sidewalls as well as a segment 5123-2 and a segment 5124-2. The subarea 5121-2 includes a segment 51211-2 aligned with the sidewall 5112-2, a segment 51213-2 aligned with the sidewall 5114-2 and a segment 51212-2 adjoining the segment 51211-2 and the segment 51213-2. The subarea 5122-2 includes a segment 51221-2 aligned with the sidewall 5115-2, a segment 51223-2 aligned with the sidewall 5111-2 and a segment 51222-2 adjoining the segment 51221-2 and the segment 51223-2.

As illustrated in FIG. 5B, for the case 511-2, the segment 51211-2, the segment 51212-2 and the segment 51213-2 overlap with no neighbor case. Therefore, the subarea 5121-2 overlaps with no neighbor case. Further, the segment 51221-2 overlaps with the neighbor case 511-3. The segment 51222-2 and the segment 51223-2 overlap with the neighbor case 511-1. Therefore, the subarea 5122-2 overlaps with two neighbor cases. Based on that one subarea overlaps with no neighbor case, it is determined that the case 511-2 is pickable.

FIG. 5C schematically illustrates a diagram of a layout 510 of a case layer and an overlap table 513 in accordance with embodiments of the present disclosure. As illustrated in FIG. 5C, the case 511-3 includes four sidewalls 5111-3, 5112-3 5114-3, 5115-3. According to the finger configuration, the gripper is configured to grip a sidewall 5112-3 and a sidewall 5114-3 connected at a corner 5113-3. That is, the sidewall 5112-3 and the sidewall 5114-3 form a first set of the target sidewalls. Further, a sidewall 5115-3 and a sidewall 5111-3 connected at a corner 5116-3 form a second set of the target sidewalls.

The layout 510 further includes a grip area 512-3 surrounding the case 511-3. The grip area 512-3 includes a subarea 5121-3 corresponding to the first set of the target sidewalls and a subarea 5122-3 corresponding to the second set of the target sidewalls as well as a segment 5123-3 and a segment 5124-3. The subarea 5121-3 includes a segment 51211-3 aligned with the sidewall 5112-3, a segment 51213-3 aligned with the sidewall 5114-3 and a segment 51212-3 adjoining the segment 51211-3 and the segment 51213-3. The subarea 5122-3 includes a segment 51221-3 aligned with the sidewall 5115-3, a segment 51223-3 aligned with the sidewall 5111-3 and a segment 51222-3 adjoining the segment 51221-3 and the segment 51223-3.

As illustrated in FIG. 5C, for the case 511-3, the segment 51211-3 and the segment 51212-3 overlap with no neighbor case. The segment 51213-3 overlaps with the neighbor case 511-4. Therefore, the subarea 5121-3 overlaps with one neighbor case. Further, the segment 51221-3 overlaps with the neighbor case 511-4. The segment 51222-3 and the segment 51223-3 overlap with the neighbor case 511-2. Therefore, the subarea 5122-3 overlaps with two neighbor cases. Based on that each subarea overlaps with at least one neighbor case, it is determined that the case 511-3 is unpickable.

FIG. 5D schematically illustrates a diagram of a layout 510 of a case layer and an overlap table 513 in accordance with embodiments of the present disclosure. As illustrated in FIG. 5D, the case 511-4 includes four sidewalls 5111-4, 5112-4, 5114-4, 5115-4. According to the finger configuration, the gripper is configured to grip the sidewall 5112-4 and the sidewall 5114-4 connected at a corner 5113-4. That is, the sidewall 5112-4 and the sidewall 5114-4 form a first set of the target sidewalls. Further, the sidewall 5115-4 and the sidewall 5111-4 connected at a corner 5116-4 form a second set of the target sidewalls.

The layout 510 further includes a grip area 512-4 surrounding the case 511-4. The grip area 512-4 includes a subarea 5121-4 corresponding to the first set of the target sidewalls and a subarea 5122-4 corresponding to the second set of the target sidewalls. The subarea 5121-4 includes a segment 51211-4 aligned with the sidewall 5112-4, a segment 51213-4 aligned with the sidewall 5114-4 and a segment 51212-4 adjoining the segment 51211-4 and the segment 51213-4. The subarea 5122-4 includes a segment 51221-4 aligned with the sidewall 5115-4, a segment 51223-4 aligned with the sidewall 5111-4 and a segment 51222-4 adjoining the segment 51221-4 and the segment 51223-4.

As illustrated in FIG. 5D, for the case 511-4, the segment 51211-4, the segment 51212-4 and the segment 51213-4 overlap with the neighbor case 511-1. Therefore, the subarea 5121-4 overlaps with one neighbor case. Further, the segment 51221-4 overlaps with the neighbor case 511-3. The segment 51222-4 and the segment 51223-4 overlap with no neighbor case. Therefore, the subarea 5122-4 overlaps with one neighbor case. Based on that each subarea overlaps with one neighbor case, it is determined that the case 511-4 is unpickable.

According to the results above, one of the four cases in the layout 510 is pickable. Therefore, the pickable case 511-2 is selected and added into the gripping sequence. After the case 511-2 is added into the gripping sequence, the layout 510 will be updated and the overlap table 513 will be updated. FIG. 5E schematically illustrate an update procedure of an overlap table in accordance with embodiments of the present disclosure. As illustrated in FIG. 5E, the overlap list of the case 511-2 is removed from the overlap table 513. Further, the data items related to the case 511-2 are replaced with null. As a result, an updated overlap table 514 is obtained. According to the updated overlap table 514, the subarea 5121-1 of the case 511-1 is clear of neighbor cases. Therefore, the case 511-1 is pickable and will be added to the gripping sequence after the case 511-2. Similarly, the cases in the gripping sequence can be all determined according to the procedure as illustrated in FIGS. 5A-5E.

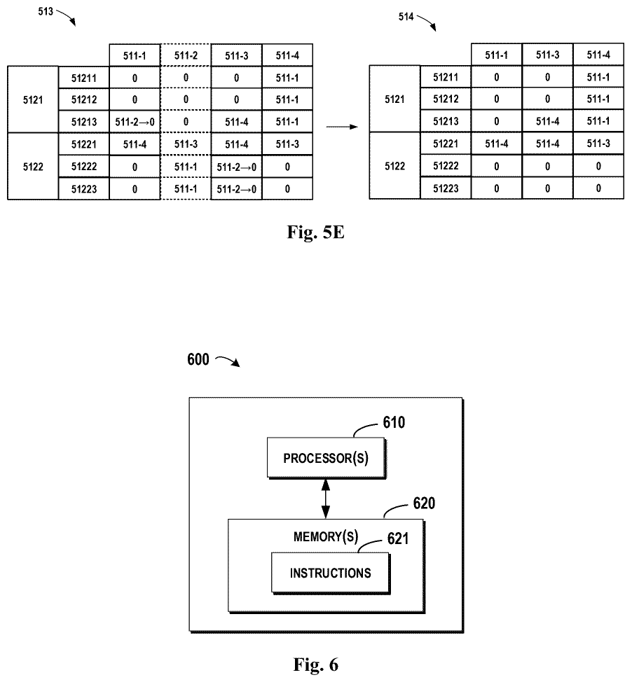

In some embodiments of the present disclosure, a computing device is provided for implementing the above methods 200, 400 and 410. FIG. 6 illustrates a schematic diagram of a controller 600 for implementing a method in accordance with embodiments of the present disclosure. The controller 600 comprises: at least one processor 610 and at least one memory 620. The at least one processor 610 may be coupled to the at least one memory 620. The at least one memory 620 comprises instructions 622 that when executed by the at least one processor 610 implements the methods 200, 400 or 410.

In some embodiments of the present disclosure, a computer readable medium for adjusting robot path is provided. The computer readable medium has instructions stored thereon, and the instructions, when executed on at least one processor, may cause at least one processor to perform the method for managing a camera system as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2, 4A and 4B. Generally, program modules include routines, programs, libraries, objects, classes, components, data structures, or the like that perform particular tasks or implement particular abstract data types. The functionality of the program modules may be combined or split between program modules as ideal in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

It is to be understood that the summary section is not intended to identify key or essential features of embodiments of the present disclosure, nor is it intended to be used to limit the scope of the present disclosure. Other features of the present disclosure will become easily comprehensible through the following description.

1. A method for determining a gripping sequence of cases in a case stack for a gripper, the gripper comprising a plurality of fingers for gripping sidewalls of the cases, the method comprising:
obtaining at least one finger geometry of the plurality of fingers;
determining a layout of cases in a case layer of the case stack;
determining, for each case in the case layer and based on the layout and the at least one finger geometry, a grip area dimensioned to allow the plurality of fingers to grip the sidewalls in the grip area;
detecting overlaps of the grip area of each case with neighbor cases of each case; and
determining the gripping sequence for the case layer based on the detected overlaps.

2. The method of claim 1, wherein determining the gripping sequence comprises:
determining whether each case in the case layer is pickable based on the detected overlaps;
selecting one pickable case as a target case; and
adding the target case into the gripping sequence.

3. The method of claim 2, wherein determining whether each case is pickable comprises:
obtaining a finger configuration indicating at least one set of target sidewalls of a case to be gripped by the fingers;
determining at least one subarea in the grip area corresponding to the at least one set of target sidewalls;
determining the overlaps of the at least one subarea with neighbor cases of the case; and
determining whether the case is pickable based on the overlaps of the at least one subarea.

4. The method of claim 3, wherein determining whether each case is pickable based on the overlaps of the at least one subarea comprises:
in response to determining that one of the at least one subarea does not overlaps with the neighbor cases, determining the case as pickable.

5. The method of claim 4, wherein determining whether each case is pickable based on the overlaps of the at least one subarea further comprises:
in response to determining that each of the at least one subarea of a case overlaps with at least one neighbor case, determining the case as unpickable.

6. The method of claim 2, wherein selecting the one pickable case comprises:
in response to determining only one case in the case layer as pickable, selecting the only one case into the gripping sequence.

7. The method of claim 6, wherein selecting the one pickable case comprises:
in response to determining a plurality of cases as pickable, obtaining a reference point in the case layer;
determining respective distances between the plurality of cases and the reference point; and
selecting a case of the plurality of cases having a minimum distance to the reference point into the gripping sequence.

8. The method of claim 6, wherein determining the gripping sequence further comprises:
maintaining an overlap list for each sub area of each case based on the detected overlaps;
updating overlap lists of neighbor cases of a case by removing overlaps with the case from the overlap lists after the case is added into the gripping sequence.

9. The method of claim 3, wherein the finger configuration indicates a corner of a case connecting two adjacent target sidewalls, and the method further comprises:
determining two adjacent target sidewalls connected at the corner as a first set of the two sets of target sidewalls.

10. The method of claim 9, wherein determining the determining two adjacent target sidewalls comprises;
identifying four corners of a case;
assigning the four corners with predefined indicators;
determining a corner with an indicator corresponding to the finger configuration; and
determining two target sidewalls connected at the corner.

11. The method of claim 4, wherein the at least one subarea includes:
a first segment adjoining a first sidewall of a set of target sidewalls corresponding to the one subarea;
a second segment adjoining a second sidewall of the pair of adjacent sidewalls; and
a third segment adjoining the first segment and the second segment.

12. The method of claim 1, wherein the case stack includes a plurality of case layers, and determining the gripping sequence comprises:
determining respective gripping sequence for each case layer in a sequence from a top case layer to a bottom case layer of the case stack.

13. The method of claim 2, further comprising:
in response to adding a target case into the gripping sequence, determining a position and a pose of the target case in the layout; and
determining a grip position and a grip pose of the gripper for gripping the target case.

14. The method of claim 1, wherein determining the layout for the case layer comprises:
obtaining an image of a top view of the case layer captured by a camera; and
generating a layout based on the image, the layout comprising profiles of cases in the case layer arranged according to poses of the cases in the image.

15. The method of claim 14, wherein a size of a profile in the layout is greater than a size of the case in the image by a predefined tolerance.

16. The method of claim 1, wherein determining the grip area comprises:
determining a predefined threshold distance based on the at least one finger geometry; and
determining a width between an inner perimeter of the grip area and an outer perimeter of the grip area to be equal to the predefined threshold distance.

17. The method of claim 16, wherein the predefined threshold distance is greater or equal to a length of a finger along a direction perpendicular to a sidewall of the case when the finger is gripping the sidewall.

18. A controller comprising:
at least one processor; and
at least one memory storing instructions that, when executed by the at least one processor, cause the controller to perform the method of claim 1.

19. A non-transitory computer readable storage medium storing instructions which, when executed by a computer, cause the computer to perform the method of claim 1.
